(19) United States
(12) Patent Application Publication
(10) Pub. No.: US 2011/0276314 A1
(43) Pub. Date: Nov. 10, 2011

(54) Method for Calculating The Sphericity of a Structure

(75) Inventor: Fredrik Orderud, Oslo (NO)

(73) Assignee: GENERAL ELECTRIC COMPANY, Schenectady, NY (US)

(21) Appl. No.: 12/774,151

(22) Filed: May 5, 2010

(51) Int. Cl. G06F 17/50

(52) U.S. Cl. 703/1

(57) ABSTRACT

Sphericity of a structure can be determined using the technology described herein. A system for determining sphericity can include a computer processor configured to compute a covariance matrix for a three dimensional model of a structure. The processor can be configured to calculate a sphericity of the structure using the covariance matrix and a long-axis vector associated with a long axis of the modeled structure. In certain embodiments, the processor can be configured to compute the sphericity as a ratio between a determinant of the covariance matrix and a cubed extent of the model in the long-axis direction. Certain embodiments can include an imaging device, such as an ultrasound scanner, for example, configured to capture an image of the structure and obtain a model of the structure. Certain embodiments can include a user interface configured to allow a user to identify the long axis of the modeled structure.

### BACKGROUND OF THE INVENTION

Embodiments of the present technology generally relate to determining the sphericity of a structure. Certain embodiments relate to determining the sphericity of a cardiac structure, such as the left ventricle.

Determining the sphericity of the left ventricle can be a useful diagnostic tool. For example, increased sphericity, such that the left ventricle is shaped more like a sphere, is associated with decreased survival and increased incidence of mitral regurgitation.

Techniques for modeling the sphericity of the left ventricle using identified landmarks on the left ventricle exist. However, known techniques have the disadvantage of being sensitive to placement of the landmarks. In other words, a sphericity value associated with a modeled left ventricle can vary significantly based on the placement of landmarks used in the modeling process. Such variability can result in uncertainty, which is not desirable in the clinical context.

Thus, there is a need for improved systems and methods that can provide for determining sphericity of a structure with improved accuracy and/or decreased variability.

### BRIEF SUMMARY OF THE INVENTION

Embodiments of the present technology provide for determining sphericity of a structure.

Certain embodiments provide a method for determining sphericity of a structure comprising: using a computer processor to compute a covariance matrix for a three dimensional model of a structure; and using the processor to calculate a sphericity of the structure using the covariance matrix and a long-axis vector associated with a long axis of the modeled structure.

In certain embodiments, the method further includes rotating the covariance matrix such that a first axis of the rotated covariance matrix is aligned with the long-axis of the modeled structure.

In certain embodiments, the sphericity is computed as a ratio between a determinant of the covariance matrix and a cubed extent of the model in the long-axis direction.

In certain embodiments, the sphericity is computed using an eigenvalued decomposition of the covariance matrix, the sphericity being computed as a ratio between a principal eigenvalue of the covariance matrix and a plurality of non-principal eigenvalues of the covariance matrix.

In certain embodiments, the three-dimensional model comprises a triangle mesh surface model.

In certain embodiments, the method further includes using an imaging device to capture an image of the structure and obtain the three dimensional model of the structure.

In certain embodiments, the imaging device comprises an ultrasound scanner.

In certain embodiments, the method further includes using the imaging device to automatically identify the long axis of the modeled structure.

In certain embodiments, the method further includes using a user interface to identify the long axis of the modeled structure.

In certain embodiments, the structure comprises a left ventricle of a human heart.

Certain embodiments provide a system for determining sphericity of a structure comprising: a computer processor configured to compute a covariance matrix for a three dimensional model of a structure, the processor configured to calculate a sphericity of the structure using the covariance matrix and a long-axis vector associated with a long axis of the modeled structure.

In certain embodiments, the processor is configured to rotate the covariance matrix such that a first axis of the rotated covariance matrix is aligned with the long-axis of the modeled structure.

In certain embodiments, the processor is configured to compute the sphericity as a ratio between a determinant of the covariance matrix and a cubed extent of the model in the long-axis direction.

In certain embodiments, the processor is configured to compute the sphericity using an eigenvalued decomposition of the covariance matrix, the sphericity being computed as a ratio between a principal eigenvalue of the covariance matrix and a plurality of non-principal eigenvalues of the covariance matrix.

In certain embodiments, the system further includes an imaging device configured to capture an image of the structure and obtain the three dimensional model of the structure.

In certain embodiments, the imaging device comprises an ultrasound scanner.

In certain embodiments, the imaging device is configured to automatically identify the long axis of the modeled structure.

In certain embodiments, the system further includes a user interface configured to allow a user to identify the long axis of the modeled structure.

Certain embodiments provide a non-transitory computer-readable storage medium encoded with a set of instructions for execution on a processing device and associated processing logic, wherein the set of instructions includes: a first routine configured to compute a covariance matrix for a three dimensional model of a structure, the first routine configured to calculate a sphericity of the structure using the covariance matrix and a long-axis vector associated with a long axis of the modeled structure.

In certain embodiments, the first routine is configured to rotate the covariance matrix such that a first axis of the rotated covariance matrix is aligned with the long-axis of the modeled structure.

In certain embodiments, the first routine is configured to compute the sphericity as a ratio between a determinant of the covariance matrix and a cubed extent of the model in the long-axis direction.

In certain embodiments, the first routine is configured to compute the sphericity using an eigenvalued decomposition of the covariance matrix, the sphericity being computed as a ratio between a principal eigenvalue of the covariance matrix and a plurality of non-principal eigenvalues of the covariance matrix.

### BRIEF DESCRIPTION OF THE DRAWINGS

FIG. 1 is a diagrammatic representation of a left ventricle that is being three-dimensionally modeled using a surface mesh technique.

FIG. 2 is a diagrammatic representation of a left ventricle with identified apex and base landmarks that are also used to provide a sphere.

FIG. 3 is a diagrammatic representation of two images of the same left ventricle depicted with apex and base landmarks identified, where one of the base landmarks is varied.

FIG. 4 is a diagrammatic representation of a left ventricle depicted with apex and base landmarks identified, and eigenvalues that can be used in connection with calculating sphericity in accordance with embodiments of the present technology.

FIG. 5 illustrates a block diagram of a system used in accordance with an embodiment of the present technology.

FIG. 6 depicts a program listing that can be used in accordance with embodiments of the present technology to calculate the volume, center of gravity and covariance matrix of a triangulated mesh.

FIG. 7 depicts a program listing that can be used in accordance with embodiments of the present technology to calculate sphericity based on a covariance matrix and a long-axis vector.

FIG. 8 illustrates a method used in accordance with an embodiment of the present technology.

The foregoing summary, as well as the following detailed description of embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF CERTAIN EMBODIMENTS

Embodiments of the present technology generally relate to determining the sphericity of a structure. Certain embodiments relate to determining the sphericity of a cardiac structure, such as the left ventricle.

While embodiments described herein are discussed in connection with determining the sphericity of a cardiac structure, such as the left ventricle, the inventions disclosed herein are not limited to this application. In other words, the inventions herein can be used to determine the sphericity of any structure for which such a determination is desired.

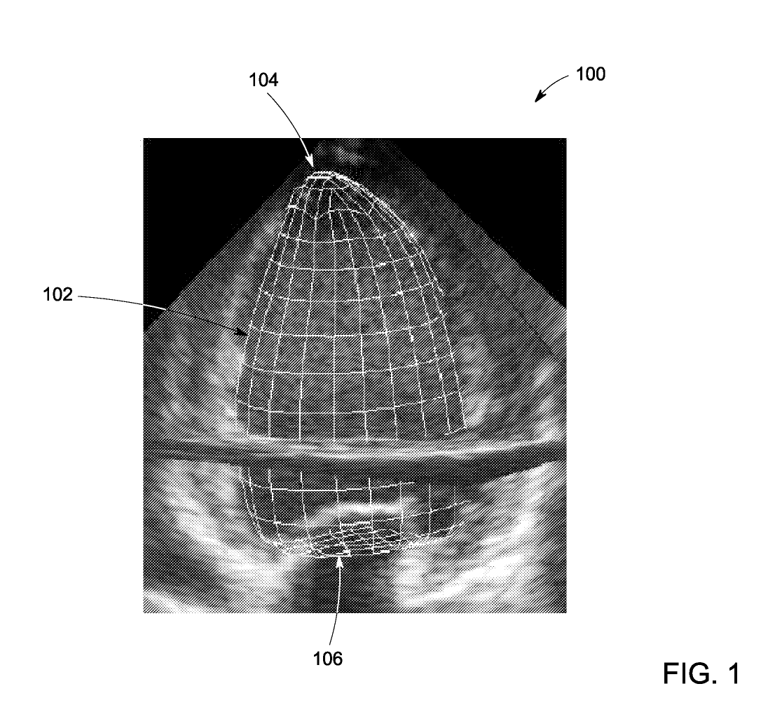

FIG. 1 is a diagrammatic representation 100 of a left ventricle 102 that is being three-dimensionally (3D) modeled using a surface mesh technique. Apex 104 and base 106 of the left ventricle 102 are depicted. Landmarks indicating the apex 104 and base 106 can be provided as a user input, or detected automatically. The surface of the left ventricle is indicated by the mesh lines. The chamber volume of the left ventricle 102 can be computed from the 3D model using the surface mesh technique. A commonly used 3D model is a triangle surface mesh, but other types of surface and solid models can also be used.

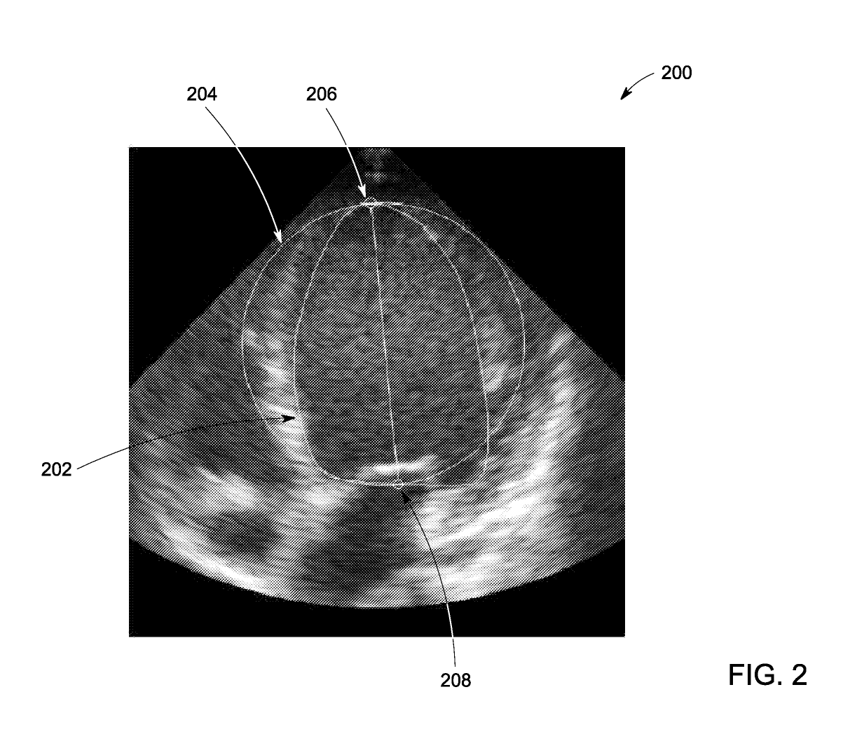

Traditionally, the sphericity of the left ventricle has been calculated as the ratio between the volume of the chamber and the volume of a sphere created using the apex and a base landmark. FIG. 2 is a diagrammatic representation 200 of a left ventricle 202 with identified apex landmark 206 and base landmark 208 that are also used to provide such a sphere 204. In this manner, sphericity has been provided using the equation:

$$sphericity = \frac{volume}{\frac{4}{3} π ( \frac{\vert apxex - base \vert}{2} ) 3}$$

A sphericity of 1 would indicate that the chamber is a sphere, whereas lower sphericity values indicate that the chamber is less akin to a sphere. A normal left ventricle may exhibit a sphericity of about 0.3, and a left ventricle with a side bulge may exhibit a sphericity of about 0.4-0.5, indicting the ventricle is more sphere-like and possibly less healthy.

It has been discovered that the traditional approach has a disadvantage of being sensitive to the positioning of the apex and base landmarks, which can vary. For example, the apex landmark can be placed differently due to foreshortening of the view, and the base landmark can be positioned differently based on conventions for handling the mitral valve.

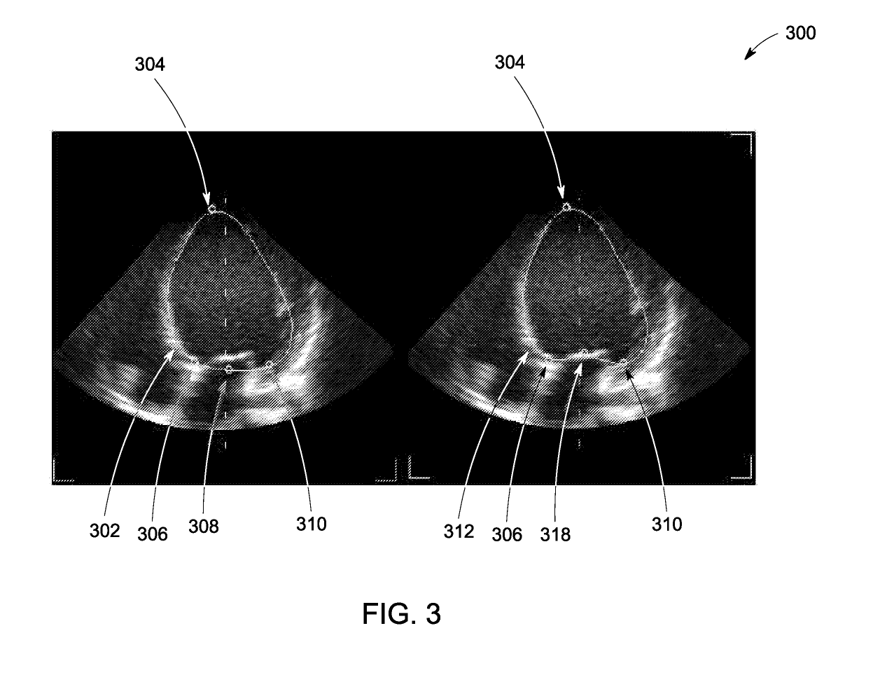

FIG. 3 is a diagrammatic representation 300 of two images of the same left ventricle depicted with apex landmark 304 and base landmarks 306, 308, 310 and 318. Base landmark 308 is different than base landmark 318, creating different shapes 302, 312 and different apex to base lengths (304 to 308 and 304 to 318). Using the traditional methods, this minor difference in landmark positioning can result in the sphericity varying from 0.60 to 0.73, a difference of 0.13.

However, applying the techniques described herein to calculate sphericity can result in sphericity varying from 0.62 to 0.63, a difference of only 0.01.

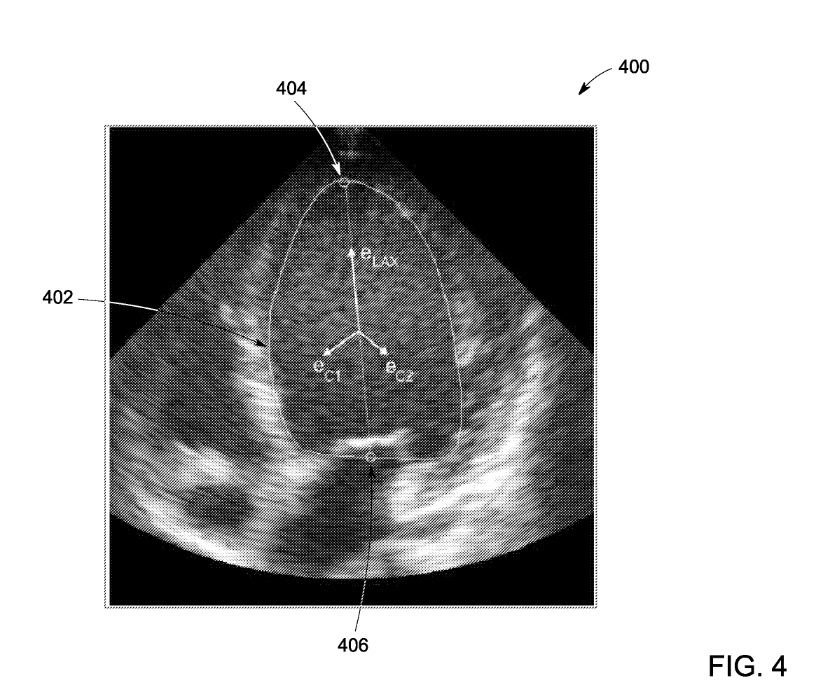

FIG. 4 is a diagrammatic representation 400 of a left ventricle 402 depicted with apex landmark 404, base landmark 406, and eigenvalues e_{LAX}, e_{C1} and e_{C2} that can be used in connection with calculating sphericity in accordance with embodiments of the present technology.

In connection with FIG. 4, sphericity can be determined as follows. First, a 3D surface model (or solid model) of the left ventricle can be created using known modeling techniques. Next, a 3×3 covariance matrix C of the model can be computed by treating the model as a solid body, and computing a solution to the following volume integral: C=∫_{V}(x−μ)(x−μ)^{T}dV, where x is the spatial coordinate vector, μ is the center of gravity, and T denotes matrix or vector transposition.

The algorithm for computing the volume integral will depend on the choice of surface representation. An example is described herein that uses a triangle surface mesh technique. However, it should be noted that the inventions described herein are not limited to use in connection with triangle surface mesh techniques, and that other surface representation techniques can be used in connection with embodiments of the present technology. Examples of other possible model representations include, but is not limited to, finite-element meshes, spline surfaces, subdivision surfaces, polygon meshes and quadrilateral meshes.

Next, a long-axis of the modeled ventricle is defined. In certain embodiments, the long-axis can be defined based on an alignment stage, where a user defines the long-axis of the model, but not the actual apex and base points. The long-axis can also be defined based on landmarks on a model. In certain embodiments, for example, the long-axis can be defined as a line through an apex landmark and a base landmark. In FIG. 4, the long axis is the line through apex landmark 404 and base landmark 406. In certain embodiments, for example, an apex landmark and a base landmark can be user selected and/or selected automatically as part of the modeling process. A third alternative is to compute the long-axis based on the principal axis of the covariance matrix. The principal axis is defined as the eigenvector associated with the eigenvalue of greatest value, based on eigenvalue decomposition of the covariance matrix.

Next, the covariance matrix is rotated with an orthogonal rotation matrix R to yield D=RCR^{T} by rotating the covariance matrix so that the first axis is aligned with the long-axis of the modeled ventricle. If the principal axis is used to determine the long-axis of the model, then the rotation vector will consist of the eigenvectors, and the resulting D matrix becomes diagonal with eigenvalues as its diagonal elements.

$$D = [ \begin{matrix}{D}_{1 , 1} & {D}_{1 , 2} & {D}_{1 , 3} \\ {D}_{2 , 1} & {D}_{2 , 2} & {D}_{2 , 3} \\ {D}_{3 , 1} & {D}_{3 , 2} & {D}_{3 , 3}\end{matrix} ]$$

The rotated covariance matrix comprises the long-axis and two arbitrary orthogonal axes. The D_{1,1} entry corresponds to the variance, or squared extent, of the model in the long-axis direction, which is illustrated as eigenvalue e_{LAX} in FIG. 4. D_{2,2} and D_{3,3} similarly correspond to the extent in the other two circumferential directions, which are illustrated as eigenvalues e_{C1} and e_{C2} in FIG. 4. The determinant |D| of the matrix is equal to the product of the eigenvalues, or the extent of the model along the long (principal) axis and the two other orthogonal axes, and therefore corresponds to the size of the model.

Next, the sphericity can be computed as the square root of the ratio between the determinant |D| and the cubed extent in the long-axis direction using the equation below.

$$sphericity = \sqrt{\frac{\vert D \vert}{{D}_{1 , 1}^{3}}} ( ≅ \frac{” height * length * width ”}{” {height}^{3} ”} )$$

The square root operation is performed to convert from quadratic variance numbers to linear standard deviation numbers that correspond to the metric extent of the model in each direction.

The actual formulas used to compute sphericity based on the rotated covariance matrix can vary, as long as the above-described principles for computation of the ratio between the extent in the long-axis direction and the other directions is followed. In certain embodiments, for example, one can compute the square-root ratio of the lower 2×2 submatrix of D, and divide that by the cubed value of D_{1,1}. This corresponds to computing the ratio between the length multiplied by the width and divided by the squared height, which gives similar results as the above formula for sphericity. Also, when using the principal axis as long-axis, the rotated covariance becomes diagonal, and the formula simplifies to the square root of D_{2,2} multiplied by D_{3,3} and divided by the square of D_{1,1}.

A perfect sphere will have all eigenvalues of equal magnitude, yielding a sphericity value of 1. Also, scaling of the model in any eigen-direction will lead to a corresponding scaling of the sphericity in the same direction. Sphericity values calculated in accordance with the principles described herein therefore reflect a structure's sphericity in the same manner as sphericity values determined using traditional methods. That is, a sphericity value of 0.5 calculated using the principles described herein means the same thing as a sphericity value of 0.5 determined using traditional methods. However, applying the principles herein can provide a sphericity value with less variability than traditional methods.

As mentioned above, a triangle mesh surface technique can be used in connection with embodiments of the present technology. Such a triangle mesh can be processed one triangle at a time. That is, for each triangle including vertices v₁, v₂ and v₃, the volume (volᵢ), centroid (μᵢ), and covariance (Cᵢ) for a tetrahedron consisting of vertices v₁, v₂ and v₃ and the origin (0,0,0), can be computed using the equations below, where the notation |A| denotes the determinant of matrix A.

$${A}_{i} = [ \begin{matrix}{v}_{1} & {v}_{2} & {v}_{3}\end{matrix} ]$$

$${vol}_{i} = \frac{1}{6} \vert {A}_{i} \vert$$

$${μ}_{i} = \frac{{v}_{1} + {v}_{2} + {v}_{3}}{4}$$

$${C}_{i} = \vert {A}_{i} \vert {A}_{i} \frac{1}{120} [ \begin{matrix}2 & 1 & 1 \\ 1 & 2 & 1 \\ 1 & 1 & 2\end{matrix} ] {A}_{i}^{T}$$

Next, the per-triangle values can be assimilated to compute an overall volume (vol), centroid (μ), and covariance (C) of the mesh using the equations below.

$$vol = {\sum }_{i} {vol}_{i}$$

$$μ = \frac{{\sum }_{i} {vol}_{i} {μ}_{i}}{vol}$$

$$C = \frac{{\sum }_{i} {C}_{i}}{vol} = {μμ}^{T}$$

Next, as described above, a long-axis of the modeled ventricle is defined, the covariance matrix is rotated with an orthogonal rotation matrix by rotating the covariance matrix so that the first axis is aligned with the long-axis of the modeled ventricle, and then the sphericity can be computed as a ratio between the determinant (extent of the model along each principal axis) and the cubed extent in the long-axis direction.

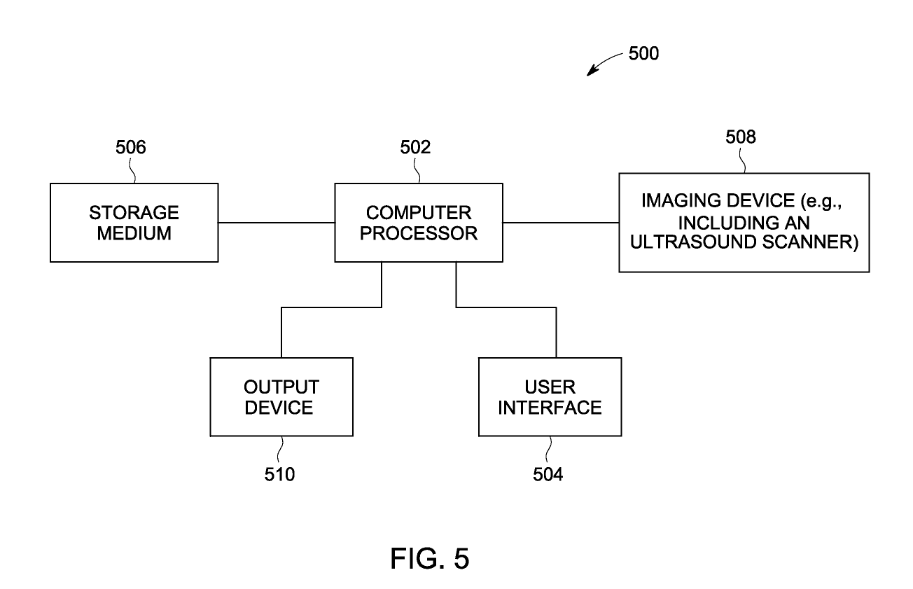

Embodiments of the present technology can be implemented in connection with a clinical information system and/or an ultrasound imaging system, for example. As depicted in FIG. 5, certain embodiments are implemented using a system 500 that includes a computer processor 502 in operable communication with a user interface 504, a storage medium 506, an imaging device 508, and an output device 510. In certain embodiments, the components of system 500 can be implemented in any combination, such as a single integrated device, or as stand-alone components in operable communication, for example.

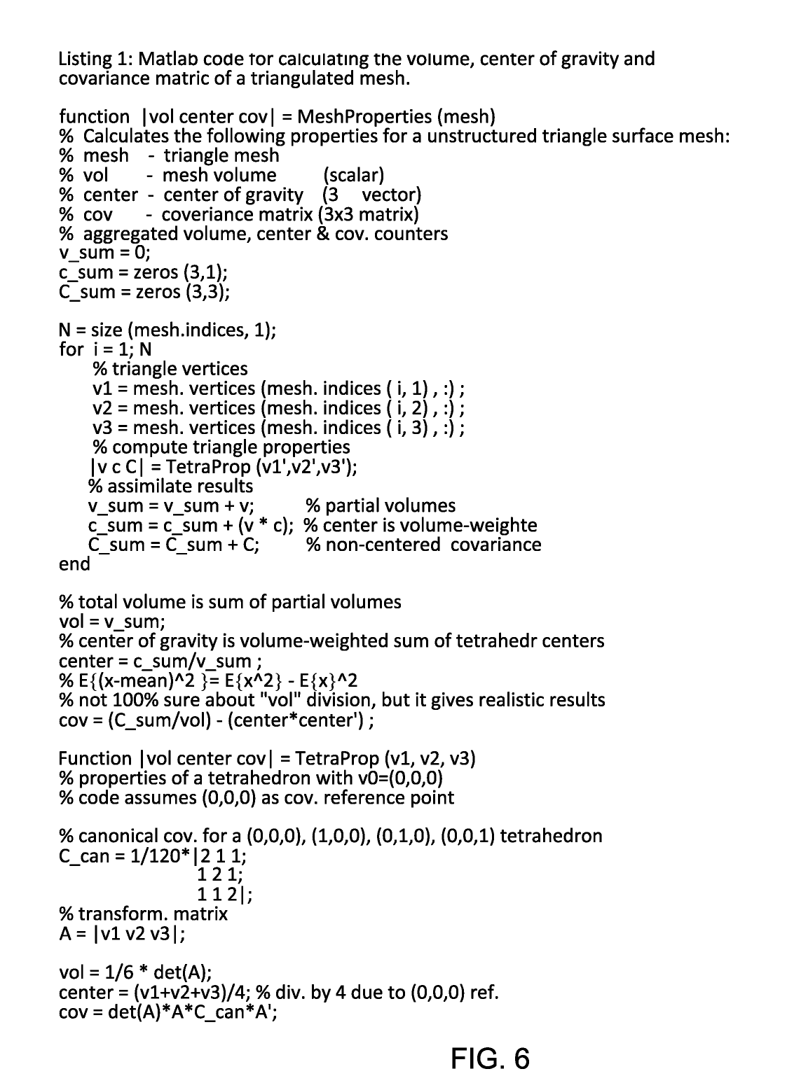

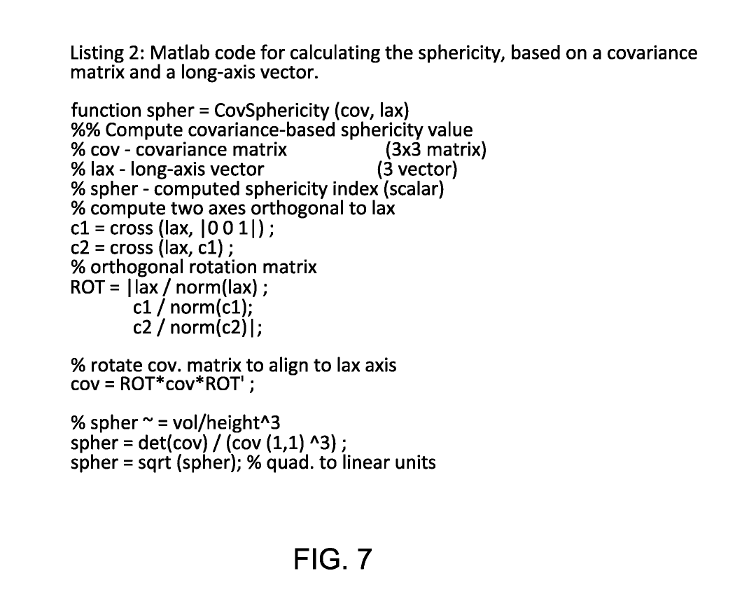

Processor 502 can be configured to execute instructions encoded on storage medium 506 and/or on another computer-readable medium. Processor 502 can be configured to facilitate communication among user interface 504, storage medium 506, imaging device 508, and output device 510. Procesor 502 can execute instructions using information from user interface 504, storage medium 506, imaging device 508, output device 510 and/or other software applications to calculate the volume, center of gravity, covariance matrix, and/or sphericity of a structure using the techniques described herein. For example, certain embodiments can be implemented using MATLAB® or other programs. For example, FIG. 6 depicts a MATLAB® program listing that can be used in accordance with embodiments of the present technology to calculate the volume, center of gravity and covariance matrix of a triangulated mesh, and FIG. 7 depicts a MATLAB® program listing that can be used in accordance with embodiments of the present technology to calculate sphericity based on a covariance matrix and a long-axis vector.

User interface 504 can be configured to allow commands to be input by a user. User interface 504 can include a keyboard, mouse, switches, knobs, buttons, track ball, touch-screen, microphone configured to receive voice-activated commands and/or on screen menus, for example. In certain embodiments, user interface 504 can be configured to allow a user to select a 3D surface model and/or a solid model. In certain embodiments, user interface 504 can be configured to allow a user to identify an apex landmark(s) and/or a base landmark(s) for a structure. In certain embodiments, user interface 504 can be configured to allow a user to define a long axis of a structure based on an alignment stage and/or from landmarks.

Storage medium 506 can be any tangible, non-transitory computer-readable medium that is readable by processor 502, whether local, remote, connected by wires and/or connected wirelessly. For example, storage medium 506 can include a computer hard drive, a server, a CD, a DVD, a USB thumb drive, and/or any other type of tangible memory capable of storing one or more computer instructions. The sets of instructions can include one or more routines capable of being run or performed by processor 502.

Imaging device 508 can be configured to capture an image of a structure, such as a left ventricle, for example. Imaging device 508 can use ultrasound, x-ray, commuted tomography and/or any other imaging modality to capture an image of the structure. In certain embodiments, imaging device 508 can be configured to automatically select a 3D surface model and/or a solid model. In certain embodiments, imaging device 508 can be configured to automatically identify an apex landmark(s) and/or a base landmark(s) for a structure. In certain embodiments, imaging device 508 can be configured to automatically define a long axis of a structure based on an alignment stage, from landmarks and/or based on the principal axes derived from eigenvectors of a covariance matrix. In certain embodiments, imaging device 508 can be an ultrasound scanner.

Output device 510 can be configured to output information from system 500, and can comprise any device suitable for this task. In certain embodiments, for example, output device 510 can output a visual display of a structure captured by imaging device 508. In certain embodiments, for example, output device 510 can output a visual display that depicts a modeled structure, landmarks on a structure and/or a long axis of the structure. In certain embodiments, for example, output device 510 can comprise a computer monitor, liquid crystal display screen, printer, fax machine, e-mail server and/or speaker, for example.

In operation, the system 500 can be used as follows to determine sphericity of a structure, such as a left ventricle, for example. An image of the structure can be acquired using imaging device 508. A 3D surface model and/or a solid model, such as a triangle mesh surface model, for example, can be selected by a user using user interface 504 or automatically by imaging device 508. The selected model can be applied.

Using processor 502, a 3×3 covariance matrix C of the model can be computed by treating the model as a solid body, and computing a solution to the volume integral: C=∫_{V}(x−μ)(x−μ)^{T}dV, where x is the spatial coordinate vector, μ is the center of gravity, and T denotes matrix or vector transposition.

A long axis for the structure can be selected by a user using user interface 504 or automatically by imaging device 508. For example, user interface 504 can be configured to allow a user to define the long axis of the structure based on an alignment stage and/or from landmarks. For example, imaging device 508 can be configured to automatically define the long axis of the structure based on an alignment stage, from landmarks and/or based on the principal axes derived from eigenvectors of the covariance matrix.

Using processor 502, the covariance matrix can be rotated with an orthogonal rotation matrix R to yield D=RCR^{T} by rotating the covariance matrix so that the first axis is aligned with the long-axis of the modeled structure. In the case of using the principal axis as long-axis for the model, this rotation step has already been performed implicitly as part of the eigenvalue decomposition, and can therefore be skipped.

Using processor 502, sphericity can be computed as a ratio between the determinant (extent of the model along each principal axis) and the cubed extent in the long-axis direction.

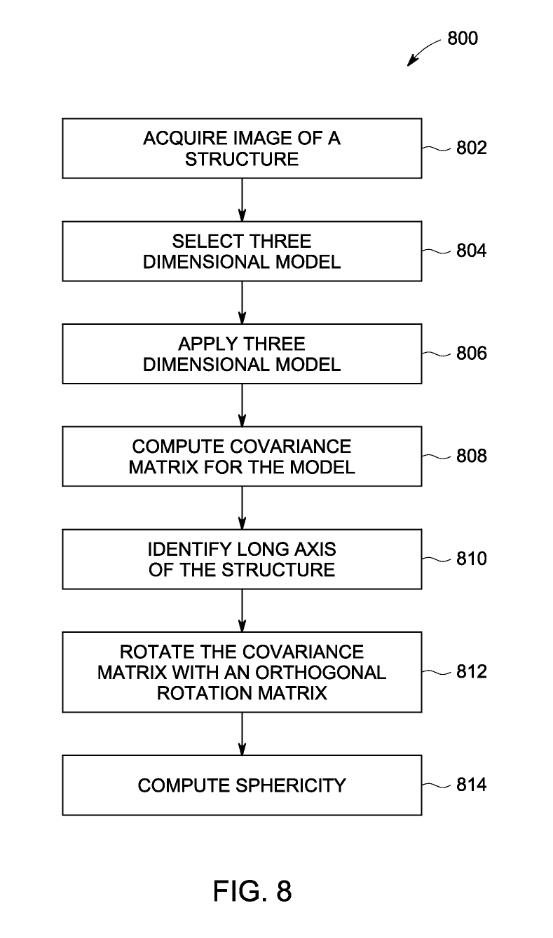

FIG. 8 illustrates a method used in accordance with an embodiment of the present technology. The method can be applied by employing the techniques and systems described herein.

At 802, an image of a structure is acquired. For example, an image of a left ventricle can be acquired using an imaging device such as an ultrasound system comprising an ultrasound scanner.

At 804, a three dimensional model is selected. For example, a 3D surface model and/or a solid model, such as a triangle mesh surface model, for example, can be selected by a user using a user interface or automatically by an imaging device. At 806, the selected three dimensional model is applied using a processor in communication with the imaging device.

At 808, a covariance matrix for the model is computed. For example, the processor can be used to execute processing logic in order to compute a 3×3 covariance matrix C of the model by treating the model as a solid body, and computing a solution to the volume integral: C=∫_{V}(x−μ)(x−μ)^{T}dV, where x is the spatial coordinate vector, g is the center of gravity, and T denotes matrix or vector transposition.

At 810, a long axis of the structure is identified. For example, a long axis for the structure can be selected by a user using a user interface or automatically by an imaging device. For example, a user interface can be configured to allow a user to define the long axis of the structure based on an alignment stage and/or from landmarks. For example, an imaging device can be configured to automatically define the long axis of the structure based on an alignment stage, from landmarks and/or based on the principal axes derived from eigenvectors of the covariance matrix.

At 812, the covariance matrix is rotated with an orthogonal rotation matrix. For example, the processor can be used to execute processing logic in order to rotate the covariance matrix with an orthogonal rotation matrix R to yield D=RCR^{T} by rotating the covariance matrix so that the first axis is aligned with the long-axis of the modeled structure. In the case of using the principal axis as long-axis for the model, this rotation step has already been performed implicitly as part of the eigenvalue decomposition, and can therefore be skipped.

At 814, sphericity is computed. For example, the processor can be used to execute processing logic in order to calculate sphericity as a ratio between the determinant (extent of the model along each principal axis) and the cubed extent in the long-axis direction.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

One or more of the steps of the method 800 may be implemented alone or in combination in hardware, firmware, and/or as a set of instructions in software, for example. Certain embodiments may be provided as a set of instructions residing on a tangible, non-transitory computer-readable medium, such as a memory, hard disk, DVD, or CD, for execution on a general purpose computer or other processing device. For example, certain embodiments provide a computer-readable storage medium encoded with a set of instructions for execution on a processing device and associated processing logic, wherein the set of instructions includes a routine(s) configured to provide the functions described in connection with the method 800.

Applying the method 800 as described above, and/or in light of the techniques and systems described herein, can provide a technical effect of determining sphericity of a structure with improved accuracy and/or decreased variability.

Certain image data acquired, analyzed and displayed in connection with the techniques described herein represent human anatomy, such as a left ventricle, for example. In other words, outputting a visual display based on such data comprises a transformation of underlying subject matter (such as an article or materials) to a different state.

While the invention has been described with reference to embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method for determining sphericity of a structure comprising:
using a computer processor to compute a covariance matrix for a three dimensional model of a structure; and
using the processor to calculate a sphericity of the structure using the covariance matrix and a long-axis vector associated with a long axis of the modeled structure.

2. The method of claim 1, further including rotating the covariance matrix such that a first axis of the rotated covariance matrix is aligned with the long-axis of the modeled structure.

3. The method of claim 1, wherein the sphericity is computed as a ratio between a determinant of the covariance matrix and a cubed extent of the model in the long-axis direction.

4. The method of claim 1, wherein the sphericity is computed using an eigenvalued decomposition of the covariance matrix, the sphericity being computed as a ratio between a principal eigenvalue of the covariance matrix and a plurality of non-principal eigenvalues of the covariance matrix.

5. The method of claim 1, wherein the three-dimensional model comprises a triangle mesh surface model.

6. The method of claim 1, further comprising using an imaging device to capture an image of the structure and obtain the three dimensional model of the structure.

7. The method of claim 6, wherein the imaging device comprises an ultrasound scanner.

8. The method of claim 6, further comprising using the imaging device to automatically identify the long axis of the modeled structure.

9. The method of claim 1, further comprising using a user interface to identify the long axis of the modeled structure.

10. The method of claim 1, wherein the structure comprises a left ventricle of a human heart.

11. A system for determining sphericity of a structure comprising:
a computer processor configured to compute a covariance matrix for a three dimensional model of a structure, the processor configured to calculate a sphericity of the structure using the covariance matrix and a long-axis vector associated with a long axis of the modeled structure.

12. The system of claim 11, wherein the processor is configured to rotate the covariance matrix such that a first axis of the rotated covariance matrix is aligned with the long-axis of the modeled structure.

13. The system of claim 11, wherein the processor is configured to compute the sphericity as a ratio between a determinant of the covariance matrix and a cubed extent of the model in the long-axis direction.

14. The system of claim 11, wherein the processor is configured to compute the sphericity using an eigenvalued decomposition of the covariance matrix, the sphericity being computed as a ratio between a principal eigenvalue of the covariance matrix and a plurality of non-principal eigenvalues of the covariance matrix.

15. The system of claim 11, further comprising an imaging device configured to capture an image of the structure and obtain the three dimensional model of the structure.

16. The system of claim 15, wherein the imaging device comprises an ultrasound scanner.

17. The system of claim 15, wherein the imaging device is configured to automatically identify the long axis of the modeled structure.

18. The system of claim 11, further comprising a user interface configured to allow a user to identify the long axis of the modeled structure.

19. A non-transitory computer-readable storage medium encoded with a set of instructions for execution on a processing device and associated processing logic, wherein the set of instructions includes:
a first routine configured to compute a covariance matrix for a three dimensional model of a structure, the first routine configured to calculate a sphericity of the structure using the covariance matrix and a long-axis vector associated with a long axis of the modeled structure.

20. The medium and instructions of claim 19, wherein the first routine is configured to rotate the covariance matrix such that a first axis of the rotated covariance matrix is aligned with the long-axis of the modeled structure.

21. The medium and instructions of claim 19, wherein the first routine is configured to compute the sphericity as a ratio between a determinant of the covariance matrix and a cubed extent of the model in the long-axis direction.

22. The medium and instructions of claim 19, wherein the first routine is configured to compute the sphericity using an eigenvalued decomposition of the covariance matrix, the sphericity being computed as a ratio between a principal eigenvalue of the covariance matrix and a plurality of non-principal eigenvalues of the covariance matrix.
